(19) United States
(12) Patent Application Publication
(10) Pub. No.: US 2010/0031020 A1
(43) Pub. Date: Feb. 4, 2010

(54) Systems and Methods for the Management and Security of Digital Idea Submissions

(76) Inventor: Norman Goldstein, Scarsdale, NY (US)

Correspondence Address: KENDRICK P. PATTERSON, 12 E. 86TH STREET, #408, NEW YORK, NY, 10028, US

(21) Appl. No.: 12/512,805

(22) Filed: Jul. 30, 2009

Related U.S. Application Data
(60) Provisional application No. 61/137,423, filed on Jul. 30, 2008.

(51) Int. Cl. H04L 9/32; G06F 17/30; H04L 29/06; G06F 15/16

(52) U.S. Cl. 713/153; 707/9; 709/206

(57) ABSTRACT

A system and method is described for managing and securing electronically submitted ideas to a central repository. Users can submit an idea to a central controller which stores that idea in digital form. The user is able to view and update the idea over time, and determine who may or may not have access to the stored files. Access to the stored information is regulated by a central controller. Such control may be dictated by the preferences of the user storing the information. The user may elect to allow only himself to have access to the information, or to allow access to trusted friends or to anyone who enters the central control or website. There is also a method for securing parental/guardian permission to share ideas generated and electronically stored when the idea is generated by a minor.

### RELATED APPLICATIONS

The present application claims the benefit of U.S. provisional patent application Ser. No. 61,137,423, filed Jul. 30, 2008, for SYSTEM AND METHODS FOR THE MANAGEMENT AND SECURITY OF DIGITAL IDEA SUBMISSIONS, by Norman Goldstein, incorporated by reference herein.

### FIELD OF THE INVENTION

The present invention relates to an electronic storage area for digital ideas and, more particularly, to a system and method to store, manage and secure digital ideas submitted with selection of the level of security made by the user.

### BACKGROUND OF THE INVENTION

People of all ages generate ideas, innovations and inventions daily. Ideas can be generated for new products, new processes, or improvements on current products and processes. These ideas in some instances might be accompanied by drawings and sketches. The storage of information into a secure database exists but a common problem with conventional databases is the inability to easily name and store these ideas and effectively manage access to the stored information. Specifically a means of submitting individual ideas into a secure storage area and having a means to allow trusted friends and/or colleagues to review the ideas while maintaining the idea as a person's own intellectual property has not been addressed adequately. In many instances when information is entered into a database, it is either available for anyone to see which compromises the creator's intellectual property or it is only available to the creator through an encrypted environment. There is a need for a technology to address this problem by creating a method and system whereby the creator/user can easily enter any idea, innovation, or invention and select a level of security for each individual idea.

A secondary problem with conventional systems for storing ideas occurs when the idea is generated by a person under the age of eighteen. The idea can be stored in a secure environment however before that idea is shared with others for review and feedback there must be permission from the legal guardian/parent of the minor who generated that idea.

### SUMMARY OF THE INVENTION

In accordance with the present invention, there is provided a system and method for managing and securing electronically submitted ideas to a central repository. The system allows for the easy submission of ideas via electronic means such as email, fax, cell phone, text message, and through a website. In an embodiment, users submit an idea (such as the design for a new toy) to a central controller which stores that idea in digital form (such as computer drawings or digitized hand sketches). The user is able to view and update the idea over time, and determine who may or may not have access to the stored files.

Access to the stored information is regulated by a central controller. Such control may be dictated by the preferences of the user storing the information. For example the user may elect to allow only himself to have access to the information. Or the user may elect to have trusted friends, a teacher, or a perspective manufacturer have access to the information. Or the user may elect to make the information public to anyone who enters the central controller or website.

Mechanisms and/or techniques are described for securing parental/guardian permission to share ideas generated and electronically stored when the idea is generated by a person who has not reached the age of majority.

### BRIEF DESCRIPTION OF THE DRAWINGS

The invention is illustrated in the figures of the accompanying drawings, which are meant to be exemplary and not limiting, in which like reference numbers indicate identical or functionally similar elements, and in which:

FIG. 1 illustrates an overall architecture of a system for managing and securing a digital idea;

FIG. 2 illustrates an operational flow for securing digital idea submissions with reference to FIG. 1;

FIG. 3 illustrates an operational flow for establishing sharing rights or policies for digital idea submissions with reference to FIG. 1;

FIG. 4 illustrates an operational flow for specifying sharing rights or policies for trusted and public networks with reference to FIG. 1; and

FIG. 5 illustrates an operational flow for invoking parental permission with reference to FIG. 1.

### DESCRIPTION OF THE PREFERRED EMBODIMENT

In the following description of embodiments of the invention, reference is made to the accompanying drawings that form a part hereof and in which is shown by way of illustration a number of specific embodiments in which the invention can be practiced. It is to be understood that other embodiments can be utilized and structural changes can be made without departing from the scope of the present invention.

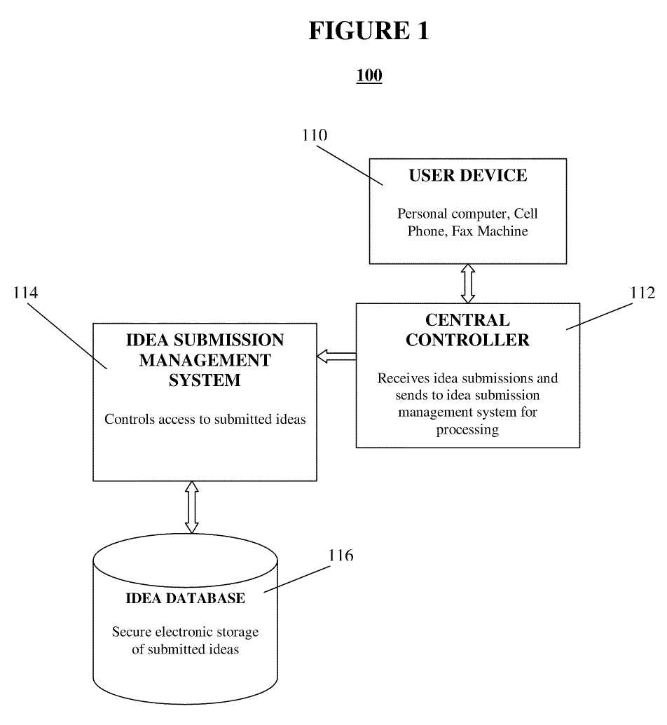

FIG. 1 illustrates an overall architecture of a system 100 for managing and securing a digital idea submission according to an embodiment of the present invention. The idea submission may be inventions, drawings, movies, designs, suggestions, formulae, recipes, and other forms of intellectual property, or the like. System 100 includes at least one user device 110 that is communicatively coupled to a central controller 112. The central controller 112 is communicatively coupled to an idea submission management system 114, which is communicatively coupled to an idea database 116.

User device 110 can be represented by a variety of devices, such as, personal computers, personal digital assistants, smart phones, cellular or mobile phones, portable media players, facsimile equipment, or the like. User device 110 includes client software, such as a resident application, applet, or web browser application, that enables a user interface to be displayed on the user device 110. For example, responsive to user interaction, user device 110 may send a Hypertext Transfer Protocol (HTTP) request to central controller 112 to access an HTTP object, Extensible Markup Language (XML) document, or the like. The HTTP object or XML document may be stored and formatted as a web page that is displayed at the user device 110 and allows the user to interact with central controller 112.

Central controller 112 responds to requests from user device 110. In an embodiment, central controller 112 receives idea submissions from user device 110 and forwards the idea submissions to idea submission management system 114 for further processing. Therefore, central controller 112 can include a software application operating on one or more servers located remotely from user device 110 or within the same facility as user device 110.

Idea submission management system 114 and idea database 116 include a relational or object oriented (OO)/component based database management system, or the like, that controls the storing, retrieving, and updating of data and metadata in the database records. The database management system also controls data integration, enforces integrity rules and constraints (including data integrity and referential integrity), and enforces security constraints. Idea database 116 is scalable to store data on multiple disk arrays. Data warehousing can be implemented with the SQL Server 2008® application available from Microsoft Corporation (Redmond, Wash.), the Oracle® 11g database available from Oracle Corporation (Redwood City, Calif.), or the like. Idea submission management system 114 and idea database 116 can support the Open DataBase Connectivity (ODBC) or Java DataBase Connectivity (JDBC) protocols.

Thus, in accordance with an embodiment of the present invention, a user-generated idea is sent from user device 110 to central controller 112 (which can be, for example, a website) where the idea is stored in idea database 116 and access to the stored idea is controlled by idea submission management system 114.

The communications link between and/or among user device 110, central controller 112, idea submission management system 114, and idea database 116 comprise network interface hardware and/or software that allow each component to transmit and receive data and/or messages. The communications link can be a wired and/or wireless local area network (LAN), virtual LAN (VLAN), wide area network (WAN), and/or metropolitan area network (MAN), such as an organization's intranet, a local internet, the global-based Internet (including the World Wide Web (WWW)), an extranet, a virtual private network (VPN), licensed wireless telecommunications spectrum for digital cell (including CDMA, TDMA, GSM, EDGE, GPRS, CDMA2000, WCDMA FDD and/or TDD or TD-SCDMA technologies), or the like. The communications link can support wired, wireless, or combinations of both transmission media, including satellite, terrestrial (e.g., fiber optic, copper, UTP, STP, coaxial, hybrid fiber-coaxial (HFC), or the like), radio, free-space optics, microwave, and/or any other form or method of transmission.

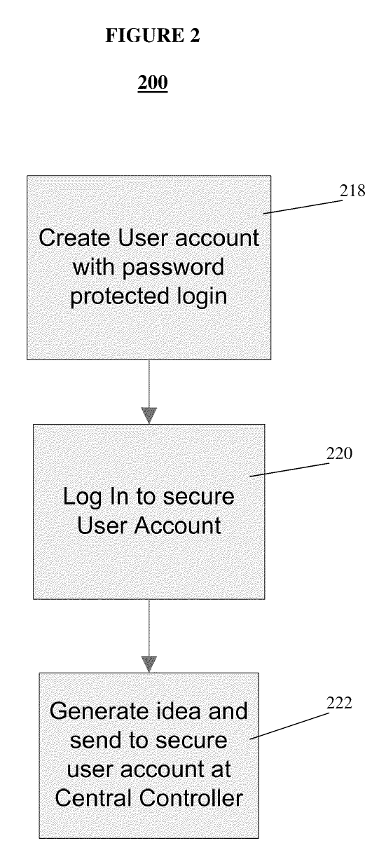

Referring to FIG. 2, a control flow 200 is illustrated for securing digital idea submissions with reference to the components of system 100. At step 218, the user creates an account with basic user login information. This account is password protected and is used when storing user-generated ideas. After successfully logging into the user account, at step 220, the ideas are sent from the user's electronic device 110 (e.g., personal computer, cell phone, fax machine, or the like) into the protected user account at the central controller 112 (e.g., a website), at step 222.

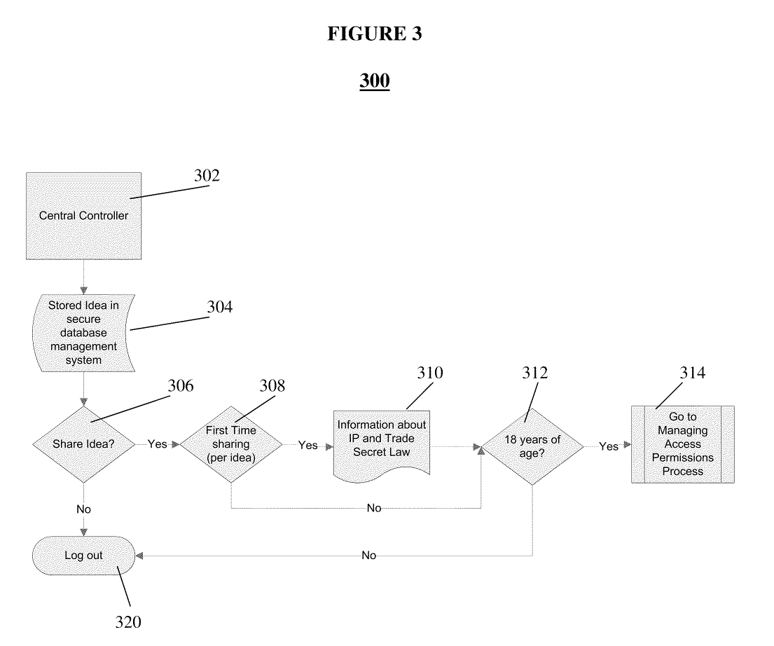

Referring to FIG. 3, a control flow 300 is illustrated for establishing the sharing rights or policies for digital idea submissions, with reference to the components of system 100. At step 302, a digital idea submission is received from a user (e.g., user device 110) at central controller 112. At step 304, the digital idea submission is sent to idea submission management system 114 for storage in the user's secured account. Once a stored idea is in the secured account of the user, the user is able to decide whether to share the idea submission, at step 306. If the user chooses not to share the information, control passes to step 320.

If the user chooses to share the idea submission, at step 308, it is determined whether it is the user's first time establishing share rights or policies. If not, the control flow 300 passes to step 312. Otherwise, control passes to step 310.

At step 310, the user is given a brief informational description or tutorial about intellectual property, and specifically a tutorial on preserving rights in Intellectual Property/Trade Secret information. This is to assist the user in deciding if the idea is to be shared with trusted friends or with the general public.

At step 312, it is determined whether the user has reached the appropriate age of majority, e.g., eighteen years of age. For example, the user can be prompted to enter his or her birthdate, or a software application may be programmed to determine the user's birthdate from other information stored within system 100. Therefore, it is determined whether the user is under the age of majority and require parental/guardian permission.

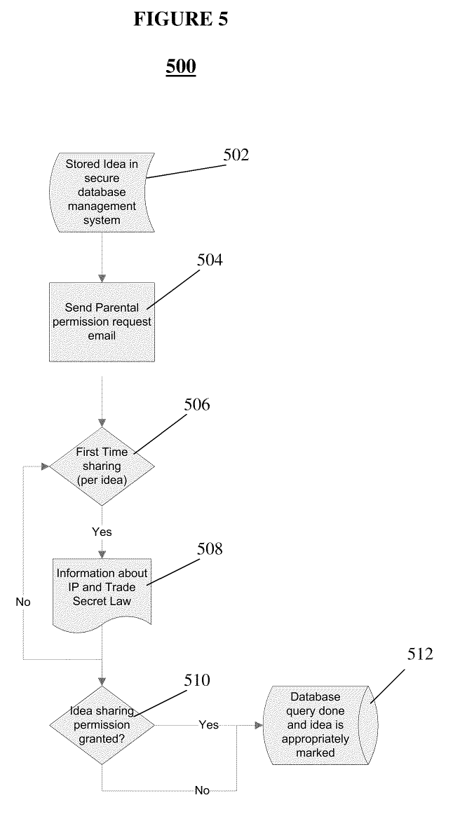

If it is determined that the user has not reached the age of majority, control passes to step 320 (see also FIG. 5). In an embodiment, the system may send an alert to the user's parent or legal guardian. The user's parent or guardian may log into the system to authorize the sharing rights in accordance with the embodiments of the present invention.

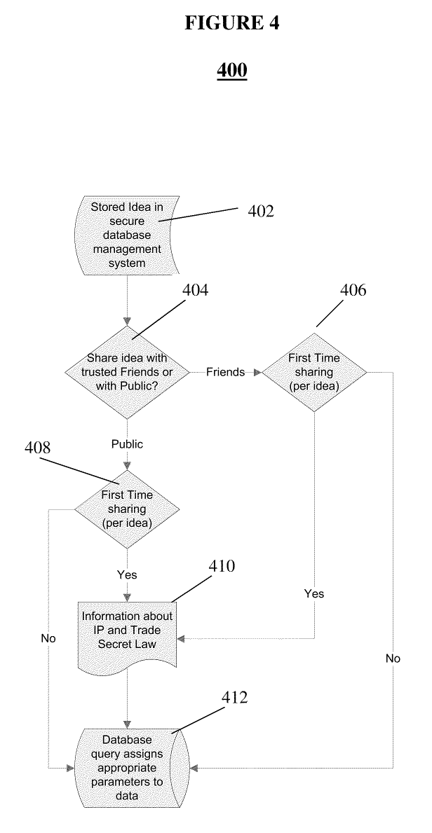

If the user has reached the age of majority, then at step 314, the user can identify the individual(s) that s/he desires to authorize access to the idea submission, and the user specifies the sharing rights or policies (see also FIG. 4). In an embodiment, the user is able to elect one of three levels of security for the idea submissions. At the highest level of security, all of the user's stored idea submissions are kept completely confidential. Thus, once an idea has been submitted to the secured account stored in idea database 116, no one else accessing the system is able to view any part of the idea submissions. In an embodiment, the submitted ideas are encrypted to prevent other users from discerning the contents, with the submitting user retaining the cryptographic key to decrypt and read the contents of his stored ideas.

At the second highest level of security, the user allows a small group of trusted people (such as a friend, teacher, family members, or the like) to have access to the stored idea submissions. For example, the user might submit an original drawing of a handbag design and elect to have the design viewable by a teacher overseeing the class project that generated the design. In this case the teacher may be provided with a password by the management system 100 which allows access to the stored design. In another embodiment, once the teacher authenticates himself to the management system 100, he is given access to all ideas for which he has been previously cleared to view by the users. In an embodiment, individuals must sign legal agreements (such as non-disclosure agreements) in order to qualify to review stored ideas.

At the lowest level of security, all submitted ideas are completely open to public review. Users selecting this security option may be warned that they could lose some intellectual property right by having their ideas open to public review.

In some embodiments, such levels of security may be determined on an idea by idea basis. For example, a user may submit three ideas and elect to have the highest levels of security applied to the first two ideas while the third idea is open for anyone to review.

In other embodiments, the level of security may be different for different aspects of the stored information. For example, a user submitting a new sporting goods design may allow others to see the name of the design and the name of the sport that it is used in, but keep all other aspects of the invention private.

In another embodiment, levels of security may be altered over time. For example, a user may specify that an idea is not to be available for anyone else to access until the publication date of a patent filed covering that idea.

In other embodiments, stored information may be transferred to third parties involved in the commercialization of the idea. For example, a user might elect to send one or more stored ideas to a third party manufacturer to facilitate the preparation of a prototype design. In another embodiment, ideas are sent to third parties such as venture capitalists for an evaluation of the commercial potential of the idea.

Once the sharing rights or policies are defined, they are stored in a user profile defining the specified user roles located at idea submission management system 114, and the control flow ends at step 320 where the user logs out.

Referring to FIG. 4, a control flow 400 is illustrated for specifying sharing rights or policies for trusted and public networks, with reference to the components of system 100. At step 402, the user accesses a stored idea from the user's secured account at idea submission management system 114, and at step 404, the user determines whether to share the stored idea with trusted individuals or the general public. If the user decides to allow trusted individuals to see and review a stored idea, then at step 406, it is determined whether it is the user's first time establishing sharing rights or policies. If not, control passes to step 412.

Otherwise, control passes to step 410, and the user is shown Intellectual Property/Trade Secret information to assist the user in making the sharing decision. At step 412, the user-specified sharing rights or policies are assigned to the stored idea submission, or part thereof, as described above.

If the user decides to allow anyone in the public to see and review a stored idea, then at step 408, it is determined whether it is the user's first time establishing sharing rights or policies. If not, control passes to step 412.

Otherwise, control passes to step 410, and the user is shown Intellectual Property/Trade Secret information to assist the user in making the sharing decision. Then at step 412, the user-specified sharing rights or policies are assigned to the stored idea submission, or part thereof, as described above.

Referring to FIG. 5, a control flow 500 is illustrated for invoking parental permission, with reference to the components of system 100. As described above, the systems and methods of the present invention include mechanisms and/or techniques for determining whether some users submitting ideas into system 100 have not reached the age of majority. They will then be routed through the parental permission control flow 500. At step 502, a stored idea is selected by a user to be shared with trusted individuals or the public if that user has been determined to have not reached the age of majority. At step 504, a process is launched to send a permission email to the parent or legal guardian of the user.

At step 506, it is determined whether it is the parent/guardian's first time establishing sharing rights or policies. If not, control passes to step 510.

Otherwise, control passes to step 508, and the parent/guardian is provided Intellectual Property/Trade Secret information to review before granting permission for the user (e.g., their child) to share a stored idea.

At step 510, the parent/guardian either selects to give permission to share the stored idea or not, and at step 512, a database query is generated to identify the user account and the user-specified sharing rights or policies are assigned to the stored idea submission, or part thereof, as described above.

In an embodiment, system 100 can be used to help children under eighteen years of age to develop and commercialize their ideas and inventions. These ideas may be inventions, drawings, movies, designs, suggestions, formulae, recipes, and other forms of intellectual property, or the like. Children would be encouraged to send digital information to central controller 112 for secure storage by idea submission management system 114. For example, a child might begin work on a new accessory for eyeglasses. The child first names the idea and creates a record in the idea submission management system 114 at the central controller 112 via a personal computer and web browser software (e.g., user device 110). The child then develops the idea, perhaps creating a series of drawings that clarify the functionality of the invention. These drawings may be scanned and transmitted directly to idea submission management system 114 for secure storage. Research conducted on the Internet may also be appended to the digital file for this child's invention stored in the idea submission management system 114. Once the idea has been more fully conceived, the child may allow the record controlled by idea submission management system 114 to be viewed by a panel of judges in an invention contest run by the central controller 112. The child may also allow his teacher to have access to the files stored in at the idea submission management system 114 in order to receive class credit for his efforts.

In an embodiment, central controller 112 can be accessible to users all over the world, and can have different idea management protocols based on the country that the submission is coming from.

FIGS. 1-5 are conceptual illustrations allowing an explanation of the present invention. It should be understood that various aspects of the embodiments of the present invention could be implemented in hardware, firmware, software, or a combination thereof. In such an embodiment, the various components and/or steps would be implemented in hardware, firmware, and/or software to perform the functions of the present invention. That is, the same piece of hardware, firmware, or module of software could perform one or more of the illustrated blocks (e.g., components or steps). Unless explicitly stated otherwise herein, the ordering or arrangement of the steps and/or components should not be limited to the descriptions and/or illustrations hereof.

In software implementations, computer software (e.g., programs or other instructions) and/or data is stored on a machine readable medium as part of a computer program product, and is loaded into a computer system or other device or machine via a removable storage drive, hard drive, or communications interface. Computer software can be implemented by any programming or scripting languages, such as Java, Javascript, Action Script, or the like. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, or the like); or the like.

Notably, the figures and examples above are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). Moreover, it is not intended for any term in the specification or claims to be ascribed an uncommon or special meaning unless explicitly set forth as such. Further, the present invention encompasses present and future known equivalents to the known components referred to herein by way of illustration. While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents

What is claimed is:

1. A method of managing and securing electronically submitted ideas to a central repository, comprising:
receiving, at a central controller from at least one user device, digital information including at least one idea generated by a first user;
storing the digital information in an idea database such that the digital information is queried in accordance with user-defined access requirements;
receiving user-defined access requirements to share the stored digital information with one or more individuals other than the first user; and
providing access to at least a portion of the stored digital information based on the user specifications.

2. The method of claim 1, wherein storing the digital information comprises:
encrypting the digital information.

3. The method of claim 1, further comprising:
associating the digital information with a user account accessed by a password.

4. The method of claim 1, wherein the receiving user-defined access requirements comprises:
receiving user-defined access requirements to grant access to at least a portion of the stored digital information to a trusted individual or to the general public.

5. The method of claim 1, further comprising:
providing an informational briefing to the user regarding intellectual property and trade secrets and concerning the implications of sharing the stored digital information.

6. The method of claim 1, further comprising:
determining whether the first user is under the age of majority.

7. The method of claim 6, comprising:
providing an alert to a parent or a legal guardian of the first user.

8. A system for managing and securing digital idea submissions, comprising:
at least one user device that receives and transmits a user-generated idea, said idea being generated by a first user;
a central controller that receives the user-generated idea and forwards the user-generated idea to a central and secure storage area; and
an idea submission management system located at the central and secure storage area,
wherein the idea submission management system assigns appropriate user-defined access to the user-generated idea stored in an idea database; and
wherein the idea submission management system receives user specifications to share at least a portion of the stored user-generate idea with one or more individuals other that the first user.

9. The system of claim 8, wherein the idea submission management system receives user specifications to share at least a portion of the stored user-generated idea with one or more trusted individuals or with the general public.

10. The system of claim 8, wherein the idea submission management system determines whether the first user is a minor.

11. The system of claim 10, wherein the idea submission management system forwards an email to a parent or a legal guardian to request permission to share at least a portion of the stored user-generated idea.
